(19) United States
(12) Patent Application Publication
(10) Pub. No.: US 2010/0309182 A1
(43) Pub. Date: Dec. 9, 2010

(54) DISPLAY APPARATUS AND METHOD OF DRIVING THE SAME

(75) Inventors: Yong-Bum KIM, Yongin-si (KR); Byung-Kil JEON, Asan-si (KR); Dong-Hyun YEO, Goyang-si (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/788,505

(22) Filed: May 27, 2010

(30) Foreign Application Priority Data
Jun. 3, 2009 (KR) 2009-0048874

(51) Int. Cl. G09G 5/00

(52) U.S. Cl. 345/208

(57) ABSTRACT

A display apparatus includes a display part, a signal control part, data driving parts, and first and second wiring pairs. The display part includes pixels. The signal control part includes a transmission part that converts an image signal into a multi-level signal. The data driving parts receive the multi-level signal from the transmission part, convert the multi-level signal into a reproduced image signal and provide the pixels with the reproduced image signal. The first and second wiring pairs connect the transmission part and at least one data driving part of the data driving parts. The multi-level signal includes serial data of the image signal and an embedding clock embedded in the serial data. A voltage level of the serial data in the multi-level signal is different from a voltage level of the embedding clock in the multi-level signal.

This application claims priority to Korean Patent Application No. 10-2009-0048874, filed on Jun. 3, 2009, and all the benefits accruing therefrom under 35 U.S.C.§119, the content of which in its entirety is herein incorporated by reference.

### BACKGROUND OF THE INVENTION

1. Field of the Invention

Exemplary embodiments of the present invention relate to a display apparatus and a method of driving the display apparatus. More particularly, exemplary embodiments of the present invention relate to a display apparatus having advantages that include, but are not limited to, maintaining clarity when displaying fast movement video thereon, as well as substantially improved electromagnetic interference (“EMI”) characteristics, and a method of driving the display apparatus.

2. Description of the Related Art

Demand for flat panel display (“FPD”) devices having high resolution is increasing. More particularly, demand for FPD devices has been rapidly increasing, due largely to the recent introduction of a high-definition television (“HDTV”) standard as a broadcasting standard.

However, when a typical FPD device displays video having rapid motion, such as is the case for many games and sports, for example, visible image blur occurs. To solve this problem, a technology has been developed in which an image frame rate of 120 images is displayed per second, instead of an image frame rate of about 60 images per second. Thus, the FPD device displays an image at a frame rate of about 120 images per second, and image blur may thereby be reduced.

To display an image frame rate of about 120 images per second, however, image data is transmitted at a high speed inside the FPD device. As a result, when the image data is transmitted at the high speed, interference between data signals is generated. Due to this interference between the data signals, electromagnetic interference (“EMI”) characteristics are substantially deteriorated inside the FPD device. Thus, a solution for improving the EMI characteristics of the FPD device is required.

### BRIEF SUMMARY OF THE INVENTION

Exemplary embodiments of the present invention provide a display apparatus which effectively prevents image blur in video with rapid movement, and which effectively prevents interference between data signals thereof, thereby substantially improving electromagnetic interference (“EMI”) characteristics of the display apparatus.

Exemplary embodiments of the present invention also provide a method of driving the display apparatus.

According to an exemplary embodiment of the present invention, a display apparatus includes a display part, a signal control part, data driving parts, a first wiring pair and a second wiring pair. The display part includes pixels. The signal control part includes a transmission part which converts an image signal into a multi-level signal. The data driving parts receive the multi-level signal from the transmission part and convert the multi-level signal into a reproduced image signal. The data driving parts provide the pixels with the reproduced image signal. The first wiring pair and the second wiring pair connect the transmission part and at least one data driving part of the data driving parts. The multi-level signal includes serial data of the first image signal and an embedding clock embedded into the serial data. A voltage level of the serial data in the multi-level signal is different from a voltage level of the embedding clock in the multi-level signal.

In an exemplary embodiment of the present invention, the multi-level signal is transmitted to the at least one data driving part through the first wiring pair, and a single-level signal is transmitted to the at least one data driving part through the second wiring pair.

In an exemplary embodiment of the present invention, the transmission part includes: a phase-locked loop circuit which determines a serialization length; and embedding parts which receive the serialization length to convert the image signal into the multi-level signal.

In an exemplary embodiment of the present invention, the embedding part includes: a serializer which generates the serial data based on the serialization length determined by the phase-locked loop circuit; and an adder which embeds the embedding clock into the serial data.

In an exemplary embodiment of the present invention, the at least one data driving part includes a sub-data driving part connected to at least one of the first wiring pairs and the second wiring pairs to convert the multi-level signal into the reproduced image signal.

In an exemplary embodiment, the sub-data driving part includes: a reference voltage generator which generates a reference voltage level; an input buffer which separates the multi-level signal into the embedding clock and the serial data based on the reference voltage level; a delay-locked loop circuit which generates a clock for parallelization based on the embedding clock, and provides a phase pulse for parallelization corresponding to the serialization length; and a parallelizer which generates the reproduced image signal by parallelizing the serial data based on the clock for parallelization and the phase pulse for parallelization.

According to an alternative exemplary embodiment of the present invention, a display apparatus includes a display part, a signal control part, data driving parts, a first wiring pair and a second wiring pair. The display part includes pixels. The signal control part includes a transmission part which converts a first image signal into a multi-level signal and a second image signal into a single-level signal. The data driving parts receive the multi-level signal and the single-level signal from the transmission part to convert the multi-level signal and the single-level signal into a reproduced first image signal and a reproduced second image signal, respectively. The data driving parts provide the pixels with the reproduced first image signal and the reproduced second image signal. The first wiring pair and the second wiring pair connect the transmission part and at least one data driving part of the data driving parts. The multi-level signal includes first serial data of the first image signal and an embedding clock embedded into the first serial data. A voltage level of the serial data in the multi-level signal is different from a voltage level of the embedding clock in the multi-level signal. The single-level signal includes second serial data of the second image signal and a dummy clock embedded into the second serial data, and a voltage level of the second serial data in the single-level signal is substantially the same as a voltage of the dummy clock in the single-level signal.

In an exemplary embodiment of the present invention, the transmission part may include: a phase-locked loop circuit which determines a serialization length; a first embedding part which receives the serialization length and converts the first image signal into the multi-level signal based on the serialization length; and a second embedding part which converts the second image signal into the single-level signal.

In an exemplary embodiment of the present invention, the first embedding part may include a first serializer which converts the first image signal into the first serial data, and a first adder which embeds the embedding clock into the first serial data. In addition, the second embedding part may include a second serializer which converts the second image signal into the second serial data, and a second adder which embeds the dummy clock into the second serial data.

In an exemplary embodiment of the present invention, the data driving part includes: a reference voltage generator which generates a reference voltage level; an input buffer which separates the multi-level signal into the embedding clock and the first serial data based on the reference voltage level, and obtains the second serial data from the single-level signal; and a delay-locked loop circuit which generates a clock for parallelization based on the embedding clock, and outputs a phase pulse for parallelization corresponding to the serialization length.

In an exemplary embodiment of the present invention, the data driving part includes: a first parallelizer which generates the reproduced first image signal by parallelizing the first serial data based on the clock for parallelization and the phase pulse for parallelization; and a second parallelizer which generates the reproduced second image signal by parallelizing the second serial data based on the clock for parallelization and the phase pulse for parallelization.

In an exemplary embodiment of the present invention, the data driving part includes: a reference voltage generator which generates a reference voltage level; an input buffer which separates the multi-level signal into the embedding clock and the serial data based on the reference voltage level, and obtains the second serial data from the single-level signal; and a delay-locked loop circuit which generates a clock for parallelization based on the embedding clock, and provides a phase pulse for parallelization corresponding to the serialization length.

The data driving part may include: a first parallelizer which converts the first serial data into parallel data based on the clock for parallelization and the phase pulse for parallelization to generate the reproduced first image signal; and a second parallelizer which converts the second serial data into parallel data based on the clock for parallelization and the phase pulse for parallelization to generate the reproduced second image signal.

According to another alternative exemplary embodiment of the present invention, a method of driving a display apparatus including a display part having pixels is provided. In the method, an image signal is converted into serial data, and an embedding clock is embedded into the serial data to generate a multi-level signal. The multi-level signal is received and converted into a reproduced image signal, and the reproduced image signal is provided to the pixels. A transmission part of the display apparatus, which converts the image signal into the serial data, and at least one data driving part of the display apparatus, are electrically connected to each other through a first wiring pair and a second wiring pair.

In an exemplary embodiment, a voltage level of the embedding clock is greater than a voltage level of the first serial data, and a voltage level of the dummy clock is substantially equal to a voltage level of the second serial data.

In an exemplary embodiment, the first image signal and the second image signal are reproduced based on a clock for parallelization and a phase pulse for parallelization generated from a delay-locked loop circuit of the display apparatus.

According to yet another alternative exemplary embodiment of the present invention, a method of driving a display apparatus including a display part having pixels is provided. In the method, a first image signal is converted into first serial data and an embedding clock is embedded into the first serial data to generate a multi-level signal. A second image signal is converted into second serial data, and a dummy clock is embedded into the second serial data to generate a single-level signal. The multi-level signal and the single-level signal are received and are converted to generate a reproduced first image signal and a reproduced second image signal, respectively, and the reproduced first image signal and the reproduced second image signal are provided to the pixels. A transmission part of the display apparatus, which transmits the multi-level signal, and at least one data driving part of the display apparatus, which receives the multi-level signal, are electrically connected to each other through a first wiring pair and a second wiring pair.

In an exemplary embodiment, a voltage level of the embedding clock is greater than a voltage level of the first serial data, and a voltage level of the dummy clock is substantially equal to a voltage level of the second serial data.

Thus, according to exemplary embodiments of the present invention, a flat panel display (“FPD”) apparatus and a method of driving the FPD apparatus are provided, in which image blur is effectively prevented from being displayed in videos including rapid movement, and interference between data signals in the interior of the FPD apparatus is effectively prevented from being generated, thereby substantially improving EMI characteristics of the FPD apparatus.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a display apparatus according to the present invention;

FIG. 2 is an equivalent circuit diagram of a pixel of the display apparatus of FIG. 1;

FIG. 3 is a block diagram of a signal control part of the display apparatus of FIG. 1;

FIG. 4 is a block diagram of an exemplary embodiment of a transmission part of a signal control part and wirings of a data driving part according to the present invention;

FIG. 5 is a block diagram of an exemplary embodiment of a transmission part of a signal control part according to the present invention;

FIG. 6 is a block diagram of an exemplary embodiment of a sub-data driving part of a data driving part according to the present invention;

FIGS. 7 and 8 are signal timing diagrams illustrating an exemplary embodiment of signals transmitted between a transmission part of a signal control part and a sub-data driving part of a data driving part according to the present invention;

FIG. 9 is a block diagram of an alternative exemplary embodiment of a transmission part of a signal control part according to the present invention;

FIG. 10 is a block diagram of another alternative exemplary embodiment of a data driving part according to the present invention;

FIG. 11 is a signal timing diagram illustrating an exemplary embodiment of a multi-level signal and a single-level signal transmitted between the transmission part and the data driving parts of the transmission part of the signal control part and the data driving part of FIGS. 9 and 10;

FIG. 12 is a signal timing diagram illustrating an exemplary embodiment of a single-level signal according to the present invention; and

FIGS. 13A and 13B are graphs of level versus frequency illustrating electromagnetic interference (“EMI”) test results for exemplary embodiments of a display apparatus according to the present invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

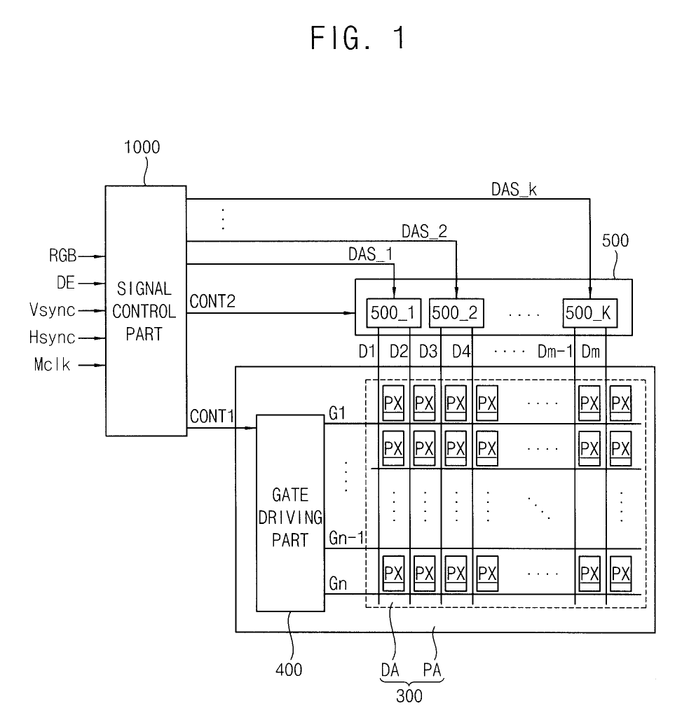

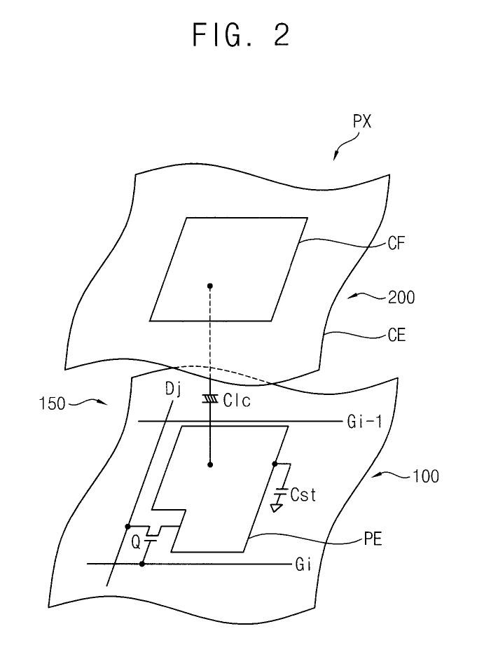

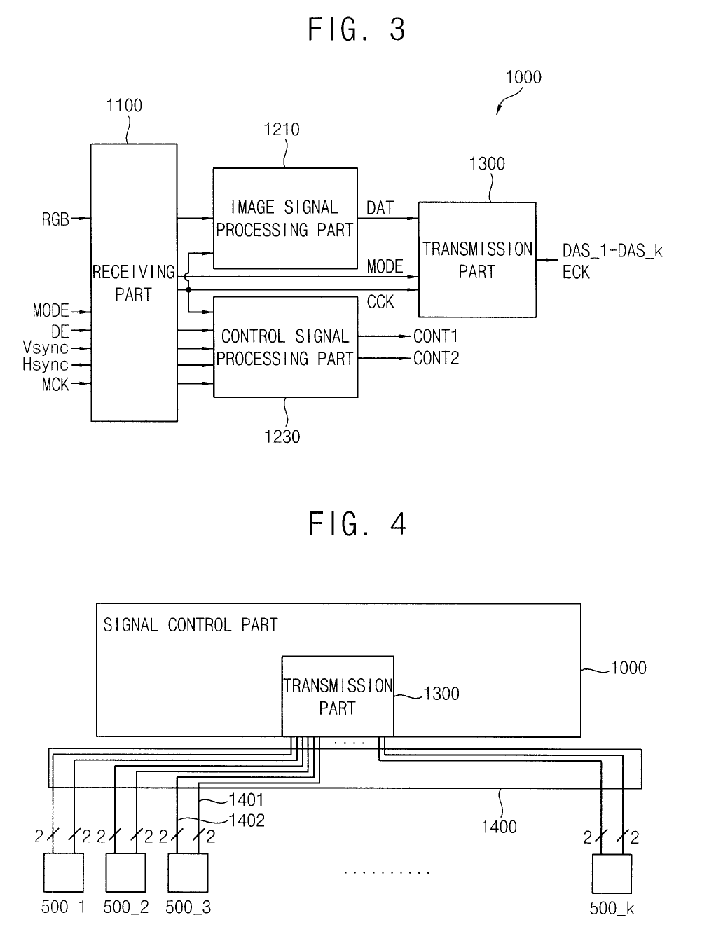

FIG. 1 is a block diagram of an exemplary embodiment of a display apparatus according to the present invention. FIG. 2 is an equivalent circuit diagram of a pixel of the display apparatus of FIG. 1. FIG. 3 is a block diagram of a signal control part of the display apparatus of FIG. 1. As shown in FIG. 1, for purposes of description herein, exemplary embodiments will described as having two data lines connected to each data driving part; however, it will be noted that alternative exemplary embodiments are not limited thereto.

Referring to FIGS. 1 and 2, a display apparatus according to an exemplary embodiment of the present invention includes a display panel 300, a signal control part 1000, a gate driving part 400 and a data driver 500 including data driving parts 500_1 through 500_K.

The display panel 300 includes gate lines G1 through Gn, data lines D1 through Dm, and pixels PX. In an exemplary embodiment, ‘n’ and ‘m’ are natural numbers. The display panel 300 may include a display area DA, where an image is displayed, and a peripheral area PA, where an image is not displayed and which surrounds the display area DA.

The display area DA displays an image using a first substrate 100 (FIG. 2), a second substrate 200 disposed opposite to, e.g., facing, the first substrate 100, and a liquid crystal layer 150 interposed between the first substrate 100 and the second substrate 200. The gate lines G1 through Gn (where ‘n’ is a natural number), the data lines D1 through Dm (where ‘m’ is a natural number), a switching element Q and the pixel electrode PE are disposed on the first substrate 100, as shown in FIG. 2. The gate lines G1 through Gn are disposed along a first, substantially row, direction (as viewed in FIG. 1) of the display DA and are substantially parallel to each other, and the data lines D1 through Dm are disposed along a second, substantially column direction of the display area DA in parallel with each other and substantially perpendicular to the first direction. The first substrate 100 is wider than the second substrate 200 to define the peripheral area PA thereon. The peripheral area PA may be a portion of the first substrate 100 on which an image is not displayed.

Referring to FIG. 2, one pixel PX of the pixels PX shown in FIG. 1 will be described in further detail. A color filter CF may be disposed on a portion of a common electrode CE of the second substrate 200 opposite the pixel electrode PE of the first substrate 100. For example, a pixel PX connected to an i-th gate line Gi (where ‘i’ is a natural number greater than or equal to 1 and less than or equal to ‘n’) and a j-th data line Dj (where ‘j’ is a natural number greater than or equal to 1 and less than or equal to ‘m’) includes a switching element Q, a liquid crystal capacitor Clc and a storage capacitor Cst connected to a corresponding switching element Q. In an alternative exemplary embodiment, the storage capacitor Cst may be omitted. The switching element Q may include an amorphous-silicon thin-film transistor (“a-Si TFT”), but alternative exemplary embodiments are not limited thereto. As shown in FIG. 2, the color filter CF and the common electrode CE are disposed on the second substrate 200; however, alternative exemplary embodiments are not limited thereto. Alternatively, for example, the color filter CF and the common electrode CE may be disposed on the first substrate 100.

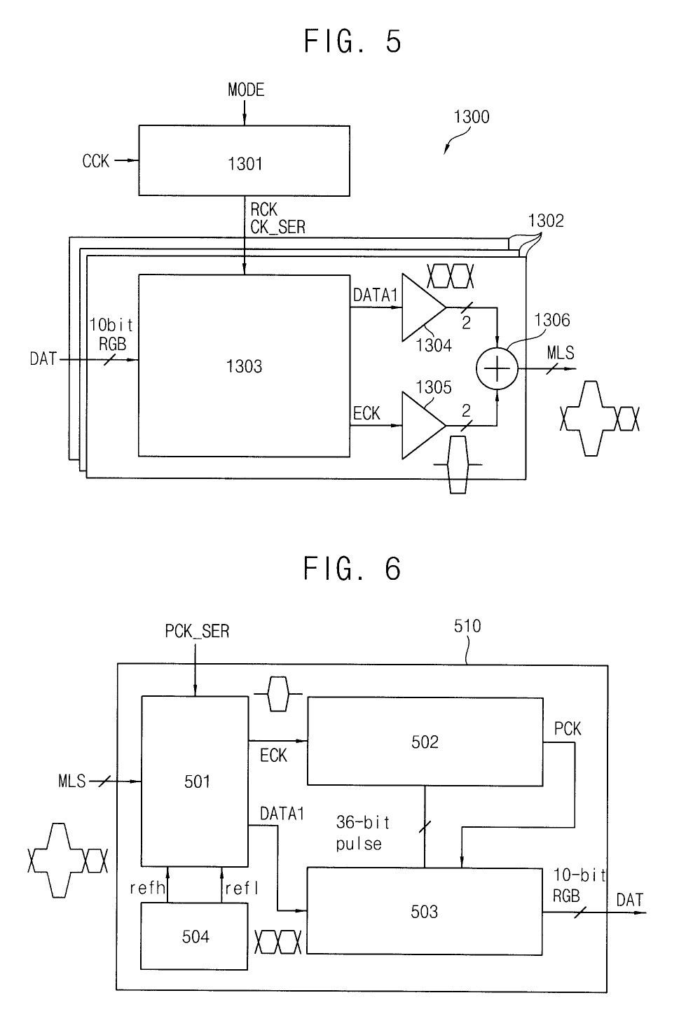

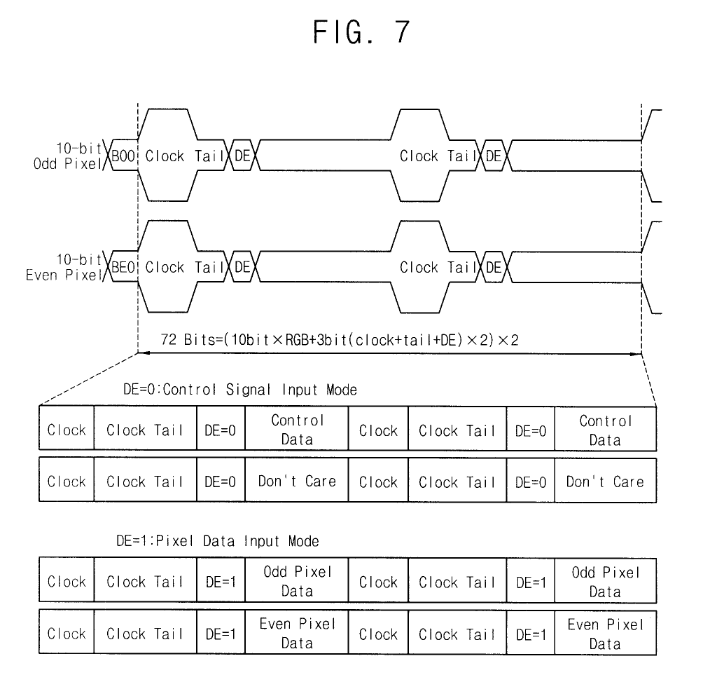

Referring again to FIG. 1, the signal control part 1000 receives a primary image signal RGB from an external graphic controller (not shown) and input control signals (described below) which control display of the primary image signal RGB, and outputs a multi-level signal MLS (FIGS. 5 and 6) to each of the data driving parts 500_1 through 500_K (hereinafter, each multi-level signal MLS outputted to a given driving part of the data driving parts 500_1 through 500_K will be individually referred to as a respective data image signal DAS_1 through DAS_k, as shown in FIGS. 1 and 3). In an exemplary embodiment, ‘K’ is a natural number. In addition, the signal control part 1000 outputs a gate control signal CONT1 and a data control signal CONT2, as shown in FIGS. 1 and 3. Referring again to FIG. 1, the input control signals received by the signal control part 1000 may include, for example, a vertical synchronizing signal Vsync, a horizontal synchronizing signal Hsync, a main clock signal Mclk and a data enable signal DE. Specifically, the vertical synchronizing signal Vsync represents a time required for displaying one frame. The horizontal synchronizing signal Hsync represents a time required for displaying one line of one frame. Thus, the horizontal synchronizing signal Hsync includes pulses corresponding to a number of the pixels PX included in one line of the display apparatus according to an exemplary embodiment. The data enable signal DE represents a time required for supplying the pixel PX with data. In an exemplary embodiment, the signal control part 1000 may include a receiving part 1100, a control signal processing part 1230, an image signal processing part 1210 and a transmission part 1300, which will be described in greater detail below with reference to FIGS. 3 and 4.

In an exemplary embodiment, the receiving part 1100 (FIG. 3) provides the control signal processing part 1230 and/or the image signal processing part 1210 with the primary image signal RGB, as well as the input control signals received from the external graphic controller (not shown) using a low voltage differential signaling (“LVDS”) type method. In addition, the receiving part 1100 generates a synchronization control signal, such as a control clock signal CCK, which is used to process the above-mentioned signals. It will be noted, however, that the method in which the signals are received from the graphic controller by the receiving part 1100 is not limited to the LVDS type. For example, the signals may be provided from the graphic controller to the receiving part 1100 through various other types of methods or configurations, such as by using a transition minimized differential signaling (“TMDS”) type method, for example.

The control signal processing part 1230 generates the gate control signal CONT1 and the data control signal CONT2 by using an input control signal and a control clock signal CCK received through the receiving part 1100. The gate control signal CONT1 is provided to the gate driving part 400 (FIG. 1) to control an operation of the gate driving part 400. The gate control signal CONT1 may include a scan start signal (not shown) which starts an operation of the gate driving part 400, and at least one gate clock signal (not shown), which controls an output period of a gate on voltage, but alternative exemplary embodiments are not limited thereto. Additionally, the gate control signal CONT1 may include an output enable signal (not shown) which adjusts a maintaining time, e.g., a time interval during which the gate on voltage is at a high level in a given period, of the gate on voltage.

The data control signal CONT2 is provided to the data driving parts 500_1 through 500_K (FIGS. 1 and 5) to control operation of the data driving parts 500_1 through 500_K. In an exemplary embodiment, for example, the data control signal CONT2 may include a horizontal start signal (not shown) which starts an operation of the data driving parts 500_1 through 500_K, a load signal (not shown) which instructs an output of data voltages to the data lines D1 through Dm, and a parallelization length signal PCK_SER, which is used in a parallelization of serial data, but alternative exemplary embodiments are not limited thereto. In addition, the data control signal CONT2 may further include an inversion signal (not shown) that inverts a polarization of the data voltage (e.g., a polarity of the data voltage with respect to a common voltage (not shown).

The image signal processing part 1210 processes the primary image signal RGB received from the receiving part 1100 and generates an image signal DAT. In an exemplary embodiment, the image signal processing part 1210 may perform a gamma correction of the primary image signal RGB to generate an image signal DAT suitable for display on the display apparatus. Additionally, the image signal processing part 1210 may over-drive the primary image signal RGB to compensate for a response time of liquid crystals (not shown) in accordance with a gradation variation between frames. In addition, the image signal processing part 1210 may process the primary image signal RGB into an interpolation image signal RGB corresponding to an interpolation frame, which is inserted between adjacent frames displayed on the display apparatus.

As will be described in further detail below with reference to FIG. 5, the transmission part 1300 generates first serial data DATA1 from the image signal DAT, and generates an embedding clock ECK from the control clock signal CCK. In addition, the transmission part 1300 generates the multi-level signal MLS, in which the embedding clock ECK is embedded within the first serial data DATA1, and provides the data driving parts 500_1 through 500_K with the multi-level signal MLS, e.g., provides the data driving parts 500_1 through 500_K with the data image signals DAS_1 through DAS_k, respectively, as shown in FIG. 1, after which the data driving parts 500_1 through 500_K convert the multi-level signal MLS back into the image signal DAT, e.g., into a reproduced image signal DAT, as will be described in greater detail below.

FIG. 4 is a block diagram of an exemplary embodiment of the transmission part 1300 of the signal control part 1000 and wiring pairs of the data driving parts 500_1 through 500_K according to the present invention.

Referring to FIG. 4, the transmission part 1300 and the data driving parts 500_1 through 500_K are connected to each other by a wiring part 1400. For example, each of the data driving parts 500_1, 500_2, . . . , 500_K is electrically connected to the transmission part 1300 via the wiring part 1400, and, more particularly, via two pairs of wires. Specifically, a third data driving part 500_3, for example, is connected to the transmission part 1300 via a first wiring pair 1401 and a second wiring pair 1402, as shown in FIG. 4. It will be noted that, although only the wiring pairs associated with the third data driving part 500_3 are labeled in FIG. 4, each of the data driving parts 500_1 through 500_K 1 is connected to the transmission part 1300 via two pairs of wiring, as shown in FIG. 4. In an exemplary embodiment, each of the data driving parts 500_1 through 500_K 1 may an integrated circuit (“IC”), but alternative exemplary embodiments are not limited thereto. Hereinafter, a structure in which the data driving parts 500_1, 500_2, . . . , 500_K and the transmission part 1300 are connected to each other by two pairs of wires will be referred to as a “dual port scheme”. When a display apparatus is operated at a frequency of 60 hertz (Hz), a transmission part and a data driving part are electrically connected to each other by one pair of wires. However, when a display apparatus is driven at a frame rate frequency of 120 Hz to display video including rapid movement, twice the transmission speed is required with respect to that of the 60 Hz frequency. Thus, using the dual port scheme, image data is parallelly transmitted at two times a transmission speed in the display apparatus driven at the frame rate of 120 Hz.

FIG. 5 is a block diagram of an exemplary embodiment of the transmission part 1300 of the signal control part 1000 according to the present invention.

Referring now to FIG. 5, the transmission part 1300 includes a phase-locked loop (“PLL”) circuit 1301 and a first embedding part 1302. The PLL circuit 1301 receives a mode signal MODE and a control clock signal CCK from the signal control part 1000. The mode signal MODE includes information (such as color depth, for example) for each of the data driving parts 500_1 through 500_K, as well as bits of gradation information. The PLL circuit 1301 determines a serialization length CK_SER based on the mode signal MODE. Additionally, the PLL circuit 1301 generates a reference clock RCK based on the control clock signal CCK. The serialization length CK_SER and the reference clock RCK are transmitted to a device that converts parallel data into serial data, which, in an exemplary embodiment, is a first serializer 1303.

The first serializer 1303 receives an image signal DAT that is parallelly inputted from the image signal processing part 1210, and receives the serialization length CK_SER and the reference clock RCK from the PLL circuit 1301. The first serializer 1303 serializes the image signal DAT based on the serialization length CK_SER and generates first serial data DATA1, and thereafter transmits the first serial data DATA1 to a first buffer 1304. Also, the first serializer 1303 generates the embedding clock ECK, based on the reference clock RCK received from the PLL circuit 1301, and transmits the embedding clock ECK to a second buffer 1305.

The first buffer 1304 and the second buffer 1305 transmit the first serial data DATA1 and the embedding clock ECK to a first adder 1306. The first adder 1306 embeds the embedding clock ECK within first serial data DATA1 and outputs the multi-level signal MLS.

FIG. 6 is a block diagram of an exemplary embodiment of a sub-data driving part 510 of each of the data driving parts 500_1 through 500_K according to the present invention.

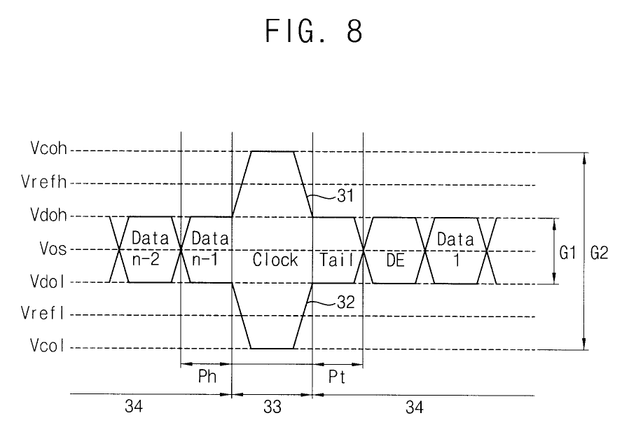

Referring to FIGS. 5 and 6, a signal, such as the multi-level signal MLS, which is received from the first adder 1306 of the transmission part 1300, is transmitted to an input buffer 501 of the sub-data driving part 510 through an associated first wiring pair 1401 (FIG. 4) of the two pairs of wires associated with each of the driving parts 500_1 through 500_K. The input buffer 501 divides the multi-level signal MLS into an embedding clock ECK and the first serial data signal DATA1 based on a reference level refh (having a reference voltage level Vrefh with respect to a voltage level Vos) (FIG. 8) and a reference level refl (having a reference voltage level Vrefl) (FIG. 8) generated by a reference signal generator 504, e.g., a reference voltage generator 504, and the parallelization length signal PCK_SER inputted from the signal control part 1000. The embedding clock ECK is provided to a delay-locked loop (“DLL”) circuit 502. The DLL circuit 502 generates a clock for parallelization PCK for transmission to a device that converts serial data into parallel data, which, in an exemplary embodiment, is a first parallelizer 503. Moreover, the DLL circuit 502 transmits a phase pulse, e.g., a 36-bit pulse (FIG. 6), for parallelization to the first parallelizer 503. When a number of bits for a gradation display is 10 bits, for example, 6 bits of control bits are added to 30 bits for RGB gradation display, and the phase pulse for parallelization has 36 bits, but alternative exemplary embodiments are not limited thereto.

The parallelizer 503 generates, for example, a first image signal DAT of 10 bits based on the clock for parallelization PCK and a phase pulse for parallelization, and transmits the first image signal DAT to a pixel of a panel.

FIGS. 7 and 8 are signal timing diagrams illustrating an exemplary embodiment of signals transmitted between the transmission part 1300 of the signal control part 1000 and the sub-data driving part 510 according to the present invention. Referring to FIGS. 7 and 8, the multi-level signal MLS transmitted between the transmission part 1300 and the data driving parts 500_1 through 500_K is a differential pair signal including a first signal 31 and a second signal 32 (FIG. 8). In an exemplary embodiment, a voltage level of the first signal 31 at a given point of time is different from a voltage level of the second signal 32, as shown in FIG. 1. More specifically, the first signal 31 of the multi-level signal MLS may be used in a first interval 34 and include the first serial data DATA1 (FIG. 5) and a control signal that controls the data driving parts 500_1 through 500_K, and the second signal 32 may be used in a second interval 33 and include the embedding clock ECK (FIG. 5).

When the multi-level signal MLS, having multi-voltage levels by embedding the embedding clock ECK into the first serial data DATA1 is used, a margin for synchronizing two signals when a clock signal and an image signal are transmitted and received is decreased, and a data transmission speed is thereby substantially increased.

In an exemplary embodiment, for example, the first signal 31 and the second signal 32 swing between voltage levels Vdoh and Vdol in the first interval 34; however, the first signal 31 and the second signal 32 swing between voltage levels Vcoh and Vcol in the second interval 33. Thus, an absolute value G1 of a level difference between the first signal 31 and the second signal 32 in the first interval 34 is different from an absolute value G2 of a level difference between the first signal 31 and the second signal 32 in the second interval 33. Thus, even though the data driving parts 500_1 through 500_K receive the multi-level signal MLS through one pair of lines, the data driving parts 500_1 through 500_K determine the first serial data DATA1 from the embedding clock ECK based on an absolute value of the level difference of the first signal 31 and the second signal 32.

In an exemplary embodiment, data information included in the first interval 34 of the multi-level signal MLS may be represented by the level difference between the first signal 31 and the second signal 32. More specifically, for example, in the first interval 34 of the image signals DAS_1 through DAS_k, data information may use a value of “1” to represent when a level of the first signal 31 is greater than that of the second signal 32, and may use a value of “0” to represent when a level of the second signal 32 is greater than that of the first signal 31.

In addition, the multi-level signal MLS according to an exemplary embodiment includes a clock head interval Ph or a clock tail interval Pt before or after the second interval 33, respectively. Thus, the multi-level signal MLS stably provides the sub-data driving parts 510 of the data driving parts 500_1 through 500_K with the last data information before the second interval 33 from the first interval 34.

Thus, in a display apparatus according to an exemplary embodiment of the present invention, the embedding clock ECK is embedded in the first serial data DATA1, and a required number of wirings is substantially decreased with respect to a conventional display apparatus. Therefore, a space between wirings is increased, and electromagnetic interference (“EMI”) characteristics are greatly enhanced in the display apparatus according to an exemplary embodiment of the present invention.

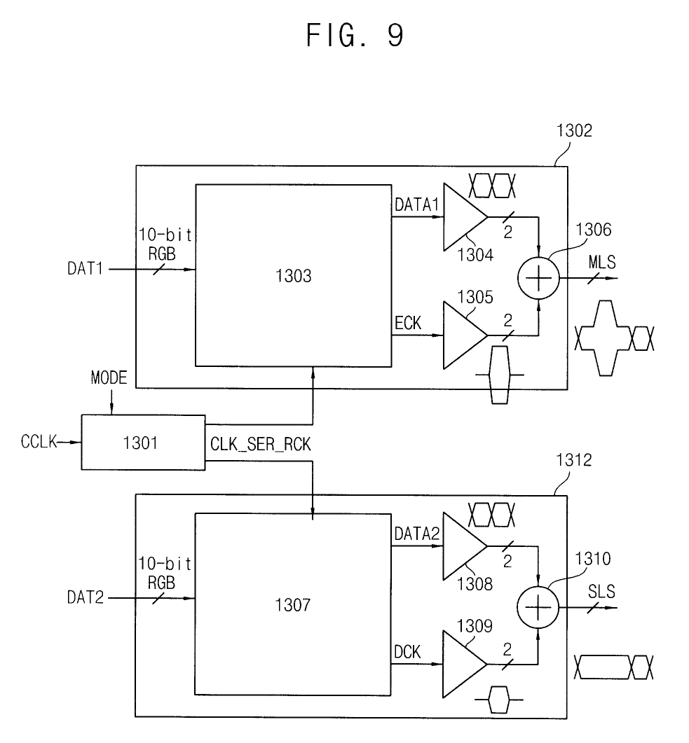

FIGS. 9 through 12 illustrate an exemplary embodiment of a method of transmitting image data at a high speed, and a flat panel display (“FPD”) apparatus that uses the method, in accordance with the present invention. In an exemplary embodiment, the display apparatus shown in FIGS. 9 through 12 uses the dual port scheme described in further detail above with reference to FIGS. 1 through 8. In an alternative exemplary embodiment, EMI characteristics are further improved, as will now be described in further detail with reference to FIGS. 9 through 12.

FIG. 9 is a block diagram of an alternative exemplary embodiment of a transmission part of a signal control part according to the present invention. The same or like components of FIG. 9 as those described in further detail above with reference to FIGS. 1 through 8 have the same reference characters in FIG. 9. Accordingly, any repetitive detailed description thereof will hereinafter be simplified or omitted.

In an exemplary embodiment, the transmission part 1300, as shown in FIG. 9, includes a first embedding part 1302 and a second embedding part 1312. A structure of the first embedding part 1302 is substantially the same as shown in FIG. 5 and described in greater detail above, and thus, a repetitive detailed description thereof will be omitted. Hereinafter, for purposes of description, image signals DAT inputted to the first embedding part 1302 and the second embedding part 1312 will be referred to as a first image signal DAT1 and a second image signal DAT2, respectively.

The second embedding part 1312 includes a second device that converts parallel data into serial data, which in an exemplary embodiment is a second serializer 1307, a third buffer 1308, a fourth buffer 1309 and second adder 1310. The second serializer 1307 receives the second image signal DAT2, which is parallelly inputted from the image signal processing part 1210, and receives a serialization length CK_SER and a reference clock RCK from the PLL circuit 1301. The second serializer 1307 serializes the second image signal DAT2 based on the serialization length CK_SER to generate a second serial data DATA2 based on the serialization length CK_SER from the PLL circuit 1301, and transmits the second serial data DATA2 to the third buffer 1308. In addition, the second serializer 1307 transmits a dummy clock DCK to the fourth buffer 1309 based on the reference clock RCK.

The third buffer 1308 and the fourth buffer 1309 transmit the second serial data DATA2 and the dummy clock DCK. In an exemplary embodiment, the dummy clock DCK has a voltage level that is substantially equal to a voltage level of an image signal. The second adder 1310 embeds the dummy clock DCK into the second serial data DATA2 to generate a single-level signal SLS. The dummy clock DCK is included in the second serial data DATA2, and a period of the multi-level signal MLS (generated by the first embedding part 1302) is thereby substantially the same as a period of the single-level signal SLS.

Thus, a multi-level signal MLS is transmitted to each of the data driving parts 500_1 through 500_K through a corresponding first wiring pair 1401 (FIG. 4), and a single-level signal SLS is transmitted to each of the data driving parts 500_1 through 500_K through a corresponding second wiring pair 1402 (FIG. 4).

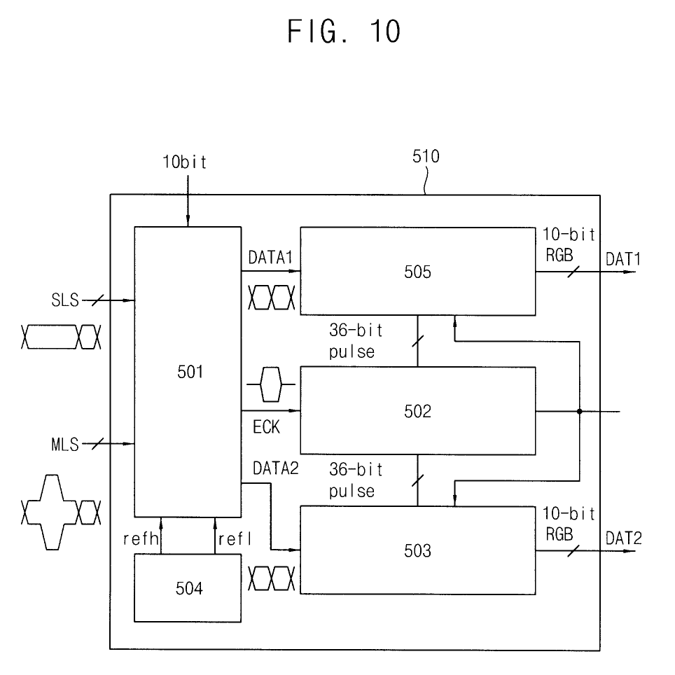

FIG. 10 is a block diagram of another alternative exemplary embodiment of a sub-data driving part 510 of the data driving parts 500_1 through 500_K according to the present invention. The same or like components of FIG. 10 as those described in further detail above with reference to FIG. 6 have the same reference characters in FIG. 10. Accordingly, any repetitive detailed description thereof will hereinafter be simplified or omitted.

Referring to FIG. 10, a signal is transmitted to an input buffer 501 of the sub-data driving part 510, which is received from an adder of a transmission part 1300 (FIG. 9) through two pairs of wires (FIG. 4). Thus, the input buffer 501 divides the multi-level signal MLS into an embedding clock ECK and first serial data DATA1 in accordance with a reference voltage level refh and refl generated by the reference voltage generator 504 and a parallelization length PCK_SER inputted from the signal control part 1000. Additionally, the input buffer 501 obtains the second serial data DATA2 from the single-level signal SLS.

The embedding clock ECK is provided to the DLL circuit 502. The DLL circuit 502 generates a clock for parallelization PCK and transmits the clock for parallelization PCK to a first parallelizer 504 and a second parallelizer 505. In addition, the DLL circuit 502 transmits a phase pulse for parallelization to the first parallelizer 503 and the second parallelizer 505. In an exemplary embodiment, for example, when a number of bits for a gradation display is 10 bits, 6 bits of control bits are added to 30 bits for RGB gradation display and the phase pulse for parallelization has 36 bits, as shown in FIG. 10.

The first parallelizer 503 and the second parallelizer 505 reproduce the first image signal DAT1 and the second image signal DAT2, respectively, each having 10 bits, based on the clock for parallelization PCK and the phase pulse for parallelization, and transmit the first image signal DAT1 and the second image signal DAT1 to a pixel PX of a display panel 300 (FIG. 1).

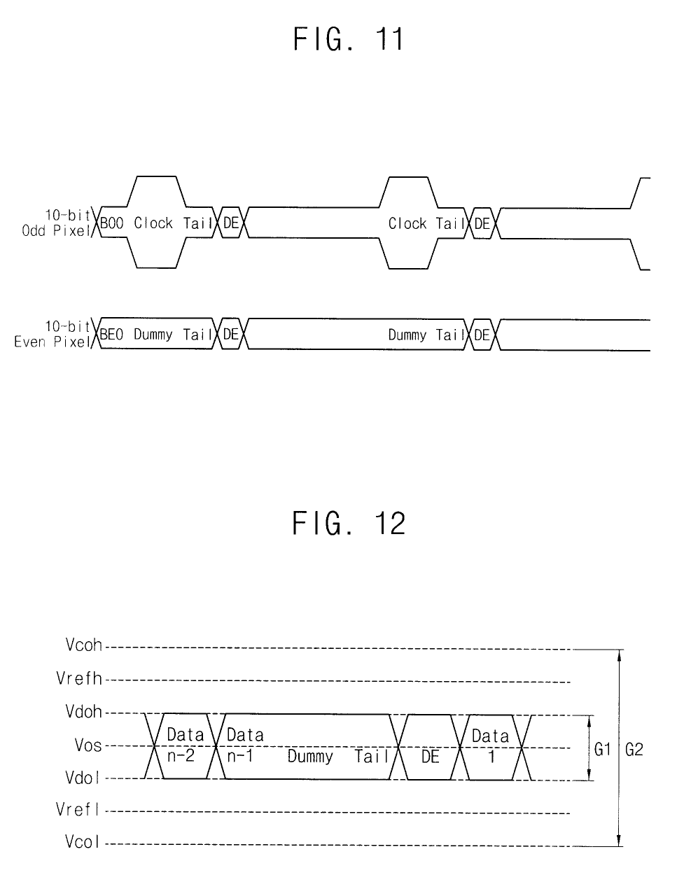

FIG. 11 is a signal timing diagram illustrating an exemplary embodiment of a multi-level signal MLS and a single-level signal SLS transmitted between the transmission part 1300 and the data driving parts 500_1 through 500_K of FIGS. 9 and 10. FIG. 12 is a signal timing diagram illustrating an exemplary embodiment of the single-level signal SLS according to the present invention.

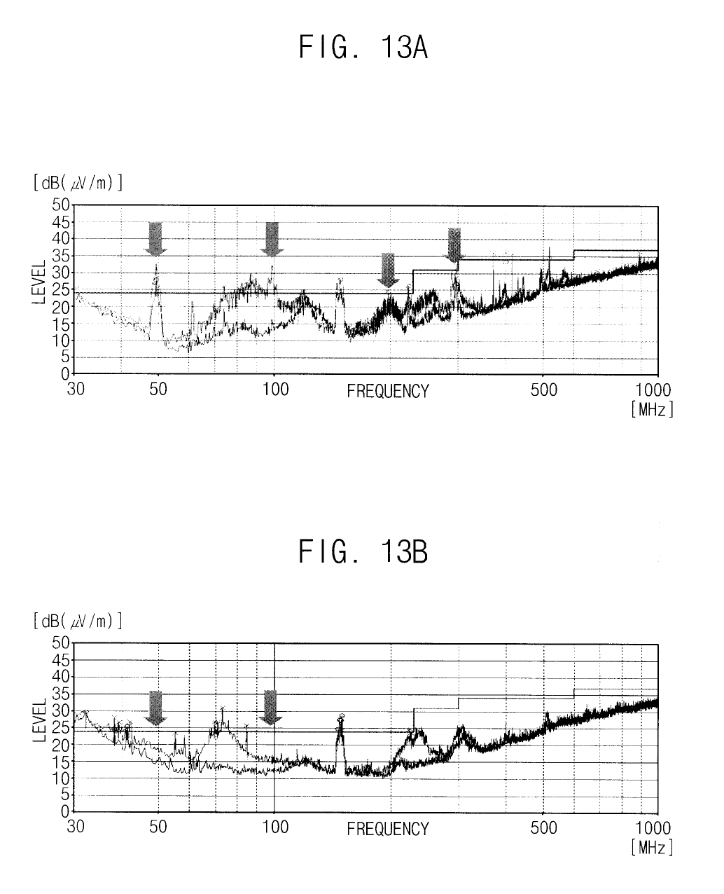

Referring to FIG. 11, in a first image signal (of two image signals), e.g., the upper image signal (as viewed in FIG. 11), the embedding clock ECK is embedded in the first serial data DATA1. In a second image signal (of the two image signals), e.g., the lower image signal (as viewed in FIG. 11), the dummy clock DCK, which has a level substantially the same as a level of the second image signal DATA2, is embedded into the first serial data DATA1 instead of the embedding clock ECK (which is embedded into the first image signal, as shown in FIG. 1 and described in greater detail above). In this case, signal interference between one pair of embedding clocks ECK is removed, and EMI characteristics of a display apparatus according to an exemplary embodiment are substantially improved, as will now be described with reference to FIGS. 13A and 13B.

FIGS. 13A and 13B are graphs of level, in decibels (dB) relative to 1 microvolt per meter (μV/m), illustrating EMI test results for an exemplary embodiment of a display apparatus, as described above with reference to FIGS. 1 through 8, and an alternative exemplary embodiment of display apparatus, as described above with reference to FIGS. 9 through 12, respectively. Referring to FIGS. 13A and 13B, it can be seen that EMI generated in the display apparatus according to the exemplary embodiment shown in FIG. 13B is reduced as compared to EMI generated in the exemplary embodiment shown in FIG. 13A. Thus, although the exemplary embodiment shown in FIG. 13A provides substantially improved EMI characteristics relative to a conventional display apparatus (as described above), the EMI characteristics of an alternative exemplary embodiment are even further improved, as shown in comparing FIGS. 13A and 13B.

Therefore, according to exemplary embodiments of the present invention as described herein, an embedding clock ECK is embedded in one of a first serial data and a second serial data, and interference between embedding clocks ECK through two pairs of wires of a dual port scheme is thereby effectively prevented. Accordingly, EMI is substantially reduced in a display apparatus according to the present invention.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A display apparatus comprising:
a display part including pixels;
a signal control part including a transmission part which converts an image signal into a multi-level signal;
data driving parts which receive the multi-level signal from the transmission part, convert the multi-level signal into a reproduced image signal and provide the pixels with the reproduced image signal; and
a first wiring pair and a second wiring pair which connect the transmission part and at least one data driving part of the data driving parts, wherein
the multi-level signal comprises serial data of the image signal and an embedding clock embedded in the serial data, and
a voltage level of the serial data in the multi-level signal is different from a voltage level of the embedding clock in the multi-level signal.

2. The display apparatus of claim 1, wherein
the multi-level signal is transmitted to the at least one data driving part through the first wiring pair, and
a single-level signal is transmitted to the at least one data driving part through the second wiring pair.

3. The display apparatus of claim 1, wherein the transmission part comprises:
a phase-locked loop circuit which determines a serialization length; and
embedding parts which receive the serialization length to convert the image signal into the multi-level signal.

4. The display apparatus of claim 3, wherein the embedding part comprises:
a serializer which generates the serial data based on the serialization length determined by the phase-locked loop circuit; and
an adder which embeds the embedding clock into the serial data.

5. The display apparatus of claim 4, wherein the at least one data driving part comprises a sub-data driving part connected to at least one of the first wiring pairs and the second wiring pairs to convert the multi-level signal into the reproduced image signal.

6. The display apparatus of claim 5, wherein the sub-data driving part comprises:
a reference voltage generator which generates a reference voltage level;
an input buffer which separates the multi-level signal into the embedding clock and the serial data based on the reference voltage level;
a delay-locked loop circuit which generates a clock for parallelization based on the embedding clock, and provides a phase pulse for parallelization corresponding to the serialization length; and
a parallelizer which generates the reproduced image signal by parallelizing the serial data based on the clock for parallelization and the phase pulse for parallelization.

7. A display apparatus comprising:
a display part including pixels;
a signal control part including a transmission part which converts a first image signal into a multi-level signal and a second image signal into a single-level signal;
data driving parts which receive the multi-level signal and the single-level signal from the transmission part, convert the multi-level signal and the single-level signal into a reproduced first image signal and a reproduced second image signal, respectively, and provide the pixels with the reproduced first image signal and the reproduced second image signal;
a first wiring pair and a second wiring pair which connect the transmission part and at least one data driving part of the data driving parts, wherein
the multi-level signal comprises first serial data of the first image signal and an embedding clock embedded into the first serial data,
a voltage level of the serial data in the multi-level signal is different from a voltage level of the embedding clock in the multi-level signal,
the single-level signal comprises second serial data of the second image signal and a dummy clock embedded into the second serial data, and
a voltage level of the second serial data in the single-level signal is substantially the same as a voltage of the dummy clock in the single-level signal.

8. The display apparatus of claim 7, wherein the transmission part comprises:
a phase-locked loop circuit which determines a serialization length;
a first embedding part which receives the serialization length and converts the first image signal into the multi-level signal based on the serialization length; and
a second embedding part which converts the second image signal into the single-level signal.

9. The display apparatus of claim 8, wherein the first embedding part comprises:
a first serializer which converts the first image signal into the first serial data; and
a first adder which embeds the embedding clock into the first serial data.

10. The display apparatus of claim 9, wherein the second embedding part comprises:
a second serializer which converts the second image signal into the second serial data; and
a second adder which embeds the dummy clock into the second serial data.

11. The display apparatus of claim 10, wherein the data driving part comprises:
a reference voltage generator which generates a reference voltage level;
an input buffer which separates the multi-level signal into the embedding clock and the first serial data based on the reference voltage level, and obtains the second serial data from the single-level signal; and
a delay-locked loop circuit which generates a clock for parallelization based on the embedding clock, and outputs a phase pulse for parallelization corresponding to the serialization length.

12. The display apparatus of claim 11, wherein the data driving part comprises:
a first parallelizer which generates the reproduced first image signal by parallelizing the first serial data based on the clock for parallelization and the phase pulse for parallelization; and
a second parallelizer which generates the reproduced second image signal by parallelizing the second serial data based on the clock for parallelization and the phase pulse for parallelization.

13. The display apparatus of claim 8, wherein the data driving part comprises:
a reference voltage generator which generates a reference voltage level;
an input buffer which separates the multi-level signal into the embedding clock and the serial data based on the reference voltage level, and obtains the second serial data from the single-level signal; and
a delay-locked loop circuit which generates a clock for parallelization based on the embedding clock, and provides a phase pulse for parallelization corresponding to the serialization length.

14. The display apparatus of claim 13, wherein the data driving part comprises:
a first parallelizer which converts the first serial data into parallel data based on the clock for parallelization and the phase pulse for parallelization to generate the reproduced first image signal; and
a second parallelizer which converts the second serial data into parallel data based on the clock for parallelization and the phase pulse for parallelization to generate the reproduced second image signal.

15. A method of driving a display apparatus including a display part having pixels, the method comprising:
converting an image signal into serial data and embedding an embedding clock into the serial data to generate a multi-level signal; and
receiving the multi-level signal to convert the multi-level signal into a reproduced image signal and providing the pixels with the reproduced image signal,
wherein a transmission part of the display apparatus, which converts the image signal into the serial data, and at least one data driving part of a plurality of data driving parts of the display apparatus, are electrically connected through a first wiring pair and a second wiring pair.

16. A method of driving a display apparatus comprising a display part having pixels, the method comprising:
converting a first image signal into first serial data and embedding an embedding clock into the first serial data to generate a multi-level signal;
converting a second image signal into second serial data and embedding a dummy clock into the second serial data to generate a single-level signal;
receiving the multi-level signal and the single-level signal to convert the multi-level signal and the single-level signal into a reproduced first image signal and a reproduced second image signal, respectively; and
providing the pixel with the reproduced first image signal and the reproduced second image signal,
wherein a transmission part of the display apparatus, which transmits the multi-level signal, and at least one data driving part of a plurality of data driving parts of the display apparatus, which receives the multi-level signal to generate the reproduced first image signal, are electrically connected to each other through a first wiring pair and a second wiring pair.

17. The method of claim 16, wherein a voltage level of the embedding clock is greater than a voltage level of the first serial data, and
a voltage level of the dummy clock is substantially equal to a voltage level of the second serial data.

18. The method of claim 16, wherein the first image signal and the second image signal are reproduced based on a clock for parallelization and a phase pulse for parallelization generated from a delay-locked loop circuit of the display apparatus.

19. The method of claim 18, wherein a voltage level of the embedding clock is greater than a voltage level of the first serial data, and
a voltage level of the dummy clock is substantially equal to a voltage level of the second serial data.
